(19) United States
(12) Patent Application Publication
(10) Pub. No.: US 2008/0029934 A1
(43) Pub. Date: Feb. 7, 2008

(54) COMPOSITE BODY MADE FROM POLYACETAL AND STYROL OLEFIN-ELASTOMERS

(75) Inventors: Ursula Ziegler, Mainz (DE); Klaus Kurz, Kelsterbach (DE); Frank Reil, Seeheim-Jugenheim (DE); Fritz A. Schmidt, Waldkraiburg (DE); Rudi Herbst, Norcross, GA (US)

Correspondence Address: CONNOLLY BOVE LODGE & HUTZ, LLP, P O BOX 2207, WILMINGTON, DE, 19899, US

(73) Assignee: TICONA GMBH, Kelsterbach (DE)

(21) Appl. No.: 11/846,964

(22) Filed: Aug. 29, 2007

Related U.S. Application Data
(63) Continuation of application No. 09/806,123, filed on May 18, 2001, now abandoned.

(30) Foreign Application Priority Data
Oct. 2, 1998 (DE) DE 19845235.7
Oct. 2, 1998 (DE) 19845235.7

(51) Int. Cl. B29C 45/03

(52) U.S. Cl. 264/328.14; 264/328.1; 524/522

(57) ABSTRACT

A composite article made from polyacetal and from at least one modified styrene-olefin elastomer, which comprises from 15 to 70% by weight, based on the weight of the modified styrene-olefin elastomer, of non-olefinic thermoplastic material, and also a process for producing the same, where a molding made from polyacetal is firstly molded, onto which is then molded a coating or at least one molding made from the modified styrene-olefin elastomer, and an adhesive bond is formed between the polyacetal and the modified styrene-olefin elastomer.

The invention relates to a composite article made from polyacetal and from styrene-olefin elastomers, and also to a process for producing the same. By modifying the styrene-olefin elastomer with non-olefinic thermoplastic material, it has been possible to obtain an adhesive bond between polyacetal and styrene-olefin elastomers.

The engineering material polyacetal, i.e. polyoxymethylene (POM), has excellent mechanical properties and is furthermore generally resistant to all of the usual solvents and fuels. Due to their good strength and hardness combined with excellent resilience, moldings made from polyacetal are very often used in all areas of daily life for snap connectors, in particular clips. Excellent sliding friction properties are the reason for the use of polyoxymethylene in many moving components, e.g. power train components, deflector rolls, gear wheels and shift levers. Moldings made from polyoxymethylene are also frequently employed in automotive construction. Very good mechanical durability and resistance to chemicals also allow a variety of housings and keyboards to be produced from polyoxymethylene.

However, POM has a low mechanical damping factor at room temperature. In some applications this makes it necessary to use soft damping elements. In addition, when incorporating moldings made from polyoxymethylene it is often necessary to use a seal at junctions. The high surface hardness of moldings made from POM and the low sliding friction coefficient of POM can cause items placed thereon to slip and can limit the operating reliability of, for example, switching units and control units made from POM.

It is, on the other hand, also increasingly common for use to be made of combinations of hard and soft materials, so as to combine the particular properties of these materials with one another. The hard material here is intended to give the components their strength, and the soft material, due to its elastic properties, assumes the functions of sealing or insulation against vibration and noise, or brings about a change in surface feel. In these applications it is important that there is sufficient adhesion between the hard and the soft component.

Until now, gaskets and damping elements have sometimes been prepared separately and, usually in an additional operation, mechanically anchored or bonded, causing additional work and in some cases considerable added cost. A newer and more cost-effective method is multicomponent injection molding, in which, for example, a second component is overmolded onto a premolded first component. The adhesion achievable between the two components is very important for this process. Although in multicomponent injection molding this adhesion can often be further improved in physical interlocks by applying intercuts, good basic adhesion with chemical affinity between the selected components is often a necessary condition for their use.

Examples which are well known are multicomponent-injection-molded combinations of polypropylene with polyolefin elastomers or with styrene-olefin elastomers or of polybutylene terephthalate with polyester elastomers or with styrene-olefin elastomers Polyamides too, adhere to very many soft components.

There are also known moldings made from polyacetal with directly molded-on functional elements, which have been produced using uncrosslinked rubbers (DE-C 44 39 766). However, bond strength in composite articles of this type is not yet satisfactory.

Another publication relates to composite articles of the same type which are composed, inter alia, of a polyacetal, a rubber copolymer, a reinforcing fillers a crosslinking agent and, if desired, other usual additives (DE-A 9611272). Particularly good adhesion of the polymer components is achieved by vulcanizing the rubber portion. However, this additional step is seen as a disadvantage, due to the increased temperatures and times for vulcanization.

Another application (German Patent Application No. 197 43 134.8, not yet laid open) relates to a process for producing composite articles made from polyacetal and from a soft component, by pre-injecting the polyacetal in a first step, in a mold, and using the lower-hardness material for overmolding in a second step so that it forms an adhesive bond to the polyacetal. For the lower-hardness region here use is made of a thermoplastic polyurethane elastomer (TPE-U) with a hardness of from Shore A 65 to Shore D 75. However, this range of hardness is too high for many applications. In addition, the thermoplastic polyurethane elastomers described have the known disadvantages in processing, e.g. moisture absorption and resultant thermal instability and variable flowability, and also mold-release problems.

Many publications describe thermoplastic polystyrene elastomers (TPE-S), in particular styrene-olefin block copolymers, as a soft component for multicomponent injection molding. However, there is no mention of combinations with polyacetals (e.g. Kunststoffe 88 (1998), pp. 207-208; Modern Plastics International, May 1998, pp. 56-61). Various thermoplastic elastomers have been claimed to be capable of combination with thermoplastics by overmolding. For example, polyurethane elastomers (TPE-U) are claimed to exhibit adhesion to POM (Kunststoffe 84 (1994), p, 709; Kunststoffe 86 (1996), p. 319). However, these publications point out expressly that no adhesion is shown between POM and TPE-S (styrene elastomers).

Finally, moldings produced by multicomponent injection molding from thermoplastics and a sound-deadening sheath made from thermoplastic elastomers have been described (DE 443-4656-C1). However, the bond in these moldings is produced mechanically by interlocks. A wide variety of materials is given both for the thermoplastic elastomers and for the thermoplastics which can be used, and these include styrene-olefin elastomers and POM. The publication does not give specific information for using these particular materials together or give advantages of a combination of this type.

The object of the present invention was to provide a composite article made from polyacetal and from thermoplastic elastomers and not having the limitations and disadvantages mentioned.

Surprisingly, it has been found that styrene-olefin elastomers which have been modified by adding non-olefinic thermoplastic material enter into an adhesive bonding with polyacetal. In contrast, styrene-olefin elastomers modified with olefinic thermoplastic material show no lasting adhesion to polyacetal.

The invention therefore provides a composite article made from polyacetal and from at least one modified styrene-olefin elastomer, which comprises from 15 to 70% by weight, based on the weight of the modified styrene-olefin elastomer, of non-olefinic thermoplastic material, and also a process for producing the same, where a molding made from polyacetal is firstly molded, onto which is then molded a coating or at least one molding made from the modified styrene-olefin elastomer, and an adhesive bond is formed between the polyacetal and the modified styrene-olefin elastomer.

The novel composite article here is formed by a polyacetal molding which has to some extent or completely been coated with the modified styrene-olefin elastomer, or onto which have been directly molded one or more moldings, also termed functional parts, made from the modified styrene-olefin elastomer. This may, for example, be a sheet-like polyacetal molding, one side of which carries a layer made from styrene-olefin elastomer. Examples of this are antislip underlays, recessed grips, control units and switching units, functional parts provided with seals or with damping elements, or also internal or external trim for bicycles, motor vehicles, aircraft, rail vehicles and watercraft, where the polyacetal provides the dimensional stability required and the elastomer layer provides the desired frictional property, sealing function, feel or appearance.

However, the composite article may also be composed of one or more polyacetal moldings of any desired form, onto which one or more moldings of any desired form made from the modified styrene-olefin elastomer have been directly molded. The expression “directly molded” means, for the purposes of the present invention, that the functional elements have been directly overmolded onto the molding made from polyacetal with which they are intended to enter into a good adhesive bond, in particular in a multicomponent injection-molding process.

Using the styrene-olefin elastomers modified with non-olefinic thermoplastic material makes it possible, for example, to mold sealing or damping elements made from the elastomers directly onto moldings made from polyacetal, without any requirement for other assembly steps.

The elimination of the process steps previously required for assembling functional elements allows a considerable cost saving to be achieved in the production of the novel composite articles.

The composite article is produced by the well-known methods and processes. It is cost-effective and advantageous to use multicomponent injection molding, in which the polyacetal is firstly molded in the injection mold, i.e. premolded, and then a coating or a molding made from the modified styrene-olefin elastomer is injected onto the polyacetal molding.

The melt temperature during the manufacture of the polyacetal molding here is within the usual range, i.e., for the polyacetals described below, in the range from about 180 to 240° C., preferably from 190 to 230° C. The mold itself is temperature-controlled to a temperature in the range from 20 to 140° C. A mold temperature in the upper part of the temperature range is advantageous for dimensional accuracy and dimensional stability of the hard component molding made from the semicrystalline polyacetal material.

As soon as the mold cavity has been completely filled and the holding pressure is no longer acting (gate sealing point), the polyacetal molding may be fully cooled and removed from the mold as the first part of the composite article (premolding). Then, in a second and subsequent separate injection-molding step, this premolding, for example, is placed or relocated into another mold with a recessed cavity, and the material with the lower hardness, i.e. the modified styrene-olefin elastomer, is injected into the mold and thereby overmolded onto the polyacetal molding. This is a known insertion or remolding process. It is particularly advantageous, in relation to the adhesion achievable subsequently, for the premolded polyacetal molding to be preheated to a temperature in the range from 80° C. to just below its melting point. This makes it easier for the overmolded styrene-olefin elastomer to begin the melting of the surface, and for it to penetrate the boundary layer.

However, it is also possible for the premolded polyacetal molding to be only partly removed from the mold and, together with a portion of the original mold (e.g. the feed plate, the ejector side or merely an indexing plate), to be moved into another larger cavity.

Another way is to inject the modified styrene-olefin elastomer into the same mold without opening up the machine between the processes and without further transportation of the premolding made from polyacetal. The mold cavities intended for the elastomer component have been initially closed off by movable inserts or cores during injection of the polyacetal component, and are not opened up until the elastomer component is injected (sliding split-mold technique). This version of the process is also particularly advantageous for achieving good adhesion, since the melt of the styrene-olefin elastomer encounters the premolding while this is still hot, after only a short cooling time.

If desired, other moldings made from polyacetal and from the modified styrene-olefin elastomers may be overmolded in the multicomponent injection-molding process, simultaneously or in sequence.

During molding-on of the modified styrene-olefin elastomers, it is advantageous for good adhesion to have very high settings for the melt temperature, the injection pressure and holding pressure. The melt temperature of the styrene-olefin elastomer is generally in the range from 200 to 270° C., the upper limit being determined by its decomposition. The values for the injection rate, and also for the injection pressure and holding pressure, depend on the machine and on the molding, and have to be adapted to the prevailing circumstances.

In all versions of the process, with or without removal of the premolding from the mold, the mold is temperature-controlled in the range from 20 to 140° C. during the second step. Depending on the design of the parts, it can be useful to lower the mold temperature somewhat, in order to optimize demoldability and cycle times. After the parts have cooled completely, the composite article is removed from the mold. In this connection it is important that the design of the mold places the ejectors at an appropriate point, so as to minimize any stress on the bonded seam between the materials. The mold design should also provide sufficient venting of the cavity in the region of the seam, so as to minimize impairment of bonding between the two components resulting from air inclusion. The nature of any roughness present on the mold wall has a similar effect. To develop good adhesion it is advantageous to have a smooth surface where the bonding seam is located, since in that case there is less air enclosed within the surface.

The tensile strength achieved by the novel process in the bond between the polyacetal molding and the modified styrene-olefin elastomers is at least 0.5 N/mm². For functional parts, greater adhesion-depending on the loading—is desirable.

The polyacetal used according to the invention has been selected from the class consisting of the known polyoxymethylenes (POMs), as described, for example, in DE-A 29 47 490. These are generally unbranched linear polymers which generally comprise at least 80 mol %, preferably at least 90 mol %, of oxymethylene (—CH₂O—) units. The term polyoxymethylene here includes both homopolymers of formaldehyde or of its cyclic oligomers, such as trioxane and tetroxane, and corresponding copolymers.

Homopolymers of formaldehyde or of trioxane are polymers whose hydroxyl end groups have been chemically stabilized in a known manner, e.g. by esterification or etherification, to prevent degradation.

Copolymers are polymers made from formaldehyde or from its cyclic oligomers, in particular trioxane, and from cyclic ethers, from cyclic acetals and/or from linear polyacetals.

Possible comonomers are on the one hand cyclic ethers having 3, 4 or 5 ring members, preferably 3 ring members, and on the other hand cyclic acetals other than trioxane having from 5 to 11 ring members, preferably 5, 6, 7 or 8 ring members, and also linear polyacetals, in each case in amounts of from 0.1 to 20 mol %, preferably from 0.5 to 10 mol %.

The polyacetal polymers used generally have a melt index (MFR 19012.16) of from 0.5 to 75 g/10 min (ISO 1133).

It is also possible to use modified grades of POM. These modified grades include, for example, blends made from POM with TPE-U (thermoplastic polyurethane elastomer), with MBS (methyl methacrylate-butadiene-styrene core shell elastomer), with methyl methacrylate-acrylate core shell elastomer, with PC (polycarbonate), with SAN (styrene-acrylonitrile copolymer) or with ASA (acrylate-styrene-acrylonitrile copolymer composition).

The modified styrene-olefin elastomers used according to the invention are compositions based on thermoplastic styrene-olefin elastomers (TPE-S). These compositions generally comprise from 20 to 85% by weight, preferably from 35 to 70% by weight, of maleic anhydride-functionalized and/or non-functionalized high-molecular-weight tri-block copolymers which have been built up from rigid end-blocks of styrene and from flexible middle blocks of olefin, and from 15 to 70% by weight, preferably from 20 to 50% by weight, of non-olefinic thermoplastic material. Based on the styrene-olefin block copolymer content, the composition comprises, in addition, at least 5 parts by weight respectively and not more than 200 parts by weight respectively of lubricating plasticizer and/or inorganic filler per 100 parts by weight of styrene-olefin block copolymer.

The styrene-olefin block copolymers to be used according to the invention are described, for example, in EP-A-710703 and EP-A-699519, which are incorporated herein by way of reference. The styrene-olefin block copolymers preferably comprise about 30 mol % of styrene and 70 mol % of olefin, the middle block of olefin having preferably been built up from ethylene units and butylene units.

By varying the proportions of functionalized and non-functionalized styrene-olefin triblock copolymers, non-olefinic thermoplastic material, plasticizer and inorganic filler it is possible to prepare modified styrene-olefin elastomers with a variety of properties. The elastomer composition may also comprise conventional stabilizers and processing aids.

The TPE-S compositions according to the invention have a Shore A hardness in the range from 30 to 90, preferably from 40 to 80. This hardness may be adjusted via the proportions of the plasticizers and of the thermoplastic component. Plasticizers which may be used are paraffinic mineral oils, synthetic oils, semisynthetic oils, ester plasticizers, etc.

The thermoplastic content in the styrene-olefin elastomers may generally be olefinic thermoplastics, such as polyethylene, polypropylene or polyolefin elastomers, if desired reinforced with talc or filled with glass fiber. However, the experiments with a styrene-olefin elastomer modified with olefinic thermoplastic material (see Comparative Experiment, B1) show that styrene-olefin elastomer compositions of this type do not adhere to polyacetal.

According to the invention, therefore, the styrene-olefin elastomer is modified by compounding with non-olefinic thermoplastic material, and the non-olefinic thermoplastic material here includes thermoplastic polymers, such as thermoplastic polyesterurethane elastomers, thermoplastic polyetherurethane elastomers, thermoplastic polyesters, such as polyethylene terephthalate and polybutylene terephthalate, thermoplastic polyesterester elastomers, thermoplastic polyetherester elastomers, thermoplastic polyetheramide elastomers, thermoplastic polyamides, thermoplastic polycarbonates, thermoplastic polyacrylates, acrylate rubbers or styrene-acrylonitrile-acrylate rubbers (ASA), if desired filled with glass fibers or with glass beads. The resultant modified styrene-olefin elastomers have a Shore A hardness in the range from about 30 to about 90, preferably from about 40 to about 80.

Both the polyacetal and the modified styrene-olefin elastomer composition may generally comprise conventional additives, such as stabilizers, nucleating agents, mold-release agents, lubricants, fillers, reinforcing materials, pigments, carbon black, light stabilizers, flame retardants, antistats, plasticizers and optical brighteners. Conventional amounts of the additives are used.

Alongside the application sectors mentioned at the outset, the novel composite articles are used as connecting elements in the form of fittings, couplings, rollers, bearings, functional parts with integrated sealing and/or damping properties, and also as elements which are non-slip and easy-grip. These include housings in automotive construction, such as door closure housings, window lifter housings, sliding roof sealing elements and the like, and also fastening elements with an integrated seal, such as clips with sealing rings or sealing disks, decorative strips with an integrated sealing lip, sealing elements for compensation in expansion joints, sealing elements with good damping properties, e.g. clips with centers for damping vibration or noise, power train components, such as gear wheels with damping elements, gear boxes with integrated flexible couplings, non-slip, easy-grip elements, such as control levers or control knobs, or grip surfaces on electrical devices or on writing implements, and also chain links with a resilient surface.

Since there was no existing measurement procedure for the bond strength between the hard polyacetal component and the soft, thermoplastically processible TPE-S component of the novel composite article, suitable measurement procedures were developed under pilot plant conditions. These procedures are intended to indicate results achievable under industrial conditions.

Test Procedures

A three-component injection molding machine was used for the injection molding experiments (Klökner-Ferromatik, Malterdingen, Germany, Model FM 175/200) and had a locking force of 2000 kN. Of the three screws available, use was made of a module of diameter 45 mm. A cavity closed off on one side was firstly used to premold, from polyacetal, ISO tensile specimens having only one shoulder. For the polyacetal grades used, the melt temperature was 200° C. and the mold temperature was 80° C.

The resultant halved tensile specimens made from polyacetal were preheated in a circulating-air heating cabinet at various temperatures Tᵢₙₛₑᵣₜ (from 20 to 155° C.) and placed while still hot, within about 20 sec, into the fully open tensile specimen mold. In a second injection-molding operation, the modified styrene-olefin elastomer was injected into the tensile specimen mold at various melt temperatures Tₘₑ (from 200 to 260° C.) and at various mold temperatures Tₘₒ (from 30 to 80° C.) at an injection rate vᵢ of from 50 to 200 mm/sec, thus molding the second shoulder of the tensile specimen. The holding pressure Pa was from 40 to 80 bar with a holding pressure time tₚₐ of from 15 to 30 sec.

The procedure described gave a complete tensile specimen with adequate adhesion and with a bonded seam between the two half specimens made from polyacetal and the modified styrene-olefin elastomer composition. These test specimens were tensile-tested (ISO 527) on a model 1455 (Zwick, Ulm, Germany) tensile test machine with a test speed of 50 mm/min. For each example, 10 composite tensile specimens were molded and tested. The results of the tensile test (stress/strain) were used to determine the ultimate tensile strength of the specimens at the bonded seam (bond strength), and the associated elongation at break. A mean value and the associated standard deviation were calculated from the values obtained for the 10 test specimens. The results are listed in Tables 1 and 2.

### EXAMPLES

### Polyacetal Components

A1: (POM MFI 9)

Polyoxymethylene copolymer made from trioxane and about 2% by weight of ethylene oxide.

Melt index MFR 190/2.16 (ISO 1133): 9 g/10 min

Modification: none

A2: (POM MFI 9+10% of TPE-U)

Polyoxymethylene copolymer made from trioxane and about 2% by weight of ethylene oxide.

Melt index MFR 190/2.16 (ISO 11333): 9 g/10 min

Modification: 10% by weight of partly aromatic polyester TPE-U made from diphenylmethane 4,4′-diisocyanate (MDI), 1,4-butanediol as chain extender, and a mixed diol polyester made from adipic acid, ethylene glycol and 1,4-butanediol, Shore hardness A 80.

A3: (POM MFI 9+20% of TPE-U)

Polyoxymethylene copolymer made from trioxane and about 2% by weight of ethylene oxide.

Melt index MFR 190/2.16 (ISO 11133): 9 g/10 min

Modification: 20% by weight of partly aromatic polyester TPE-U made from diphenylmethane 4,4′-diisocyanate (MDI) 1,4-butanediol as chain extender, and a mixed diol polyester made from adipic acid, ethylene glycol and 1,4-butanediol, Shore hardness A 80.

A4: (POM MFI 9+13% of MBS)

Polyoxymethylene copolymer made from trioxane and about 2% by weight of ethylene oxide.

Melt index MFR 190/2.16 (ISO 1133): 9 g/10 min

Modification: 13% by weight of MBS core-shell modifier made from about 80% by weight of flexible polybutadiene core and 20% by weight of MMA-styrene shell with a particle size of about 100 nm.

A5: (POM MFI 9+25% of MBS)

Polyoxymethylene copolymer made from trioxane and about 2% by weight of ethylene oxide.

Melt index MFR 190/2.16 (ISO 1133): 9 g/10 min

Modification: 25% by weight of MBS core-shell modifier made from about 80% by weight of flexible polybutadiene core and 20% by weight of MMA-styrene shell with a particle size of about 100 nm.

A6: (® Deirin 500 P, DuPont, Geneva, Switzerland)

Polyoxymethylene homopolymer made from formaldehyde

Melt index MFR 190/2.16 (ISO 1133): 14 g/10 min

stabilization and mold-release agents as commercially available

A7: (® Ultraform N 2320, BASF AG, Ludwigshafen, Germany)

Polyoxymethylene copolymer made from trioxane and about 2.7% by weight of butanediol formal, melt index MFR 190/2.16 (ISO 1133): 9 g10 min

stabilization and mold-release agents as commercially available

Elastomer Components:

B0:

partly aromatic polyester TPE-U made from diphenylmethane 4,4′-diisocyanate (MDI), 1,4-butanediol as chain extender and polyesterdiol made from adipic acid and 1,4-butanediol, Shore hardness A 83, density 1.20 g/cm³, MVR 210/2.16 (ISO 1133): 6c m³/10 min. No mold-release agent.

B1: TPE-S+olefinic thermoplastic material

Thermolast K grade TC 6 AAA; Shore hardness A 58, density 1.19 g/cm³; composition made from high-molecular-weight styrene-ethylene-butylene-styrene (SEBS) block copolymer, lubricating plasticizer, polypropylene, inorganic filler and stabilizer.

B2: TPE-S+non-olefinic thermoplastic material

Thermolast K STC 7480/44; Shore hardness A 75, density 1.05 g/cm³ composition made from high-molecular-weight, functionalized and non-functionalized SEBS block copolymer, lubricating plasticizer, non-olefinic thermoplastic (proportion 40% by weight), inorganic filler and stabilizer, using, per 100 parts by weight of SEBA block copolymer, 80 parts by weight of nonolefinic thermoplastic and at least 5 parts by weight of, respectively, lubricating plasticizer and filler.

B3: TPE-S+non-olefinic thermoplastic material

Thermolast K STC 7849/42; Shore hardness A 75, density 1.15 g/cm³; composition made from high-molecular-weight, functionalized and non-functionalized SEBS block copolymer, lubricating plasticizer, non-olefinic thermoplastic (proportion 44% by weight), inorganic filler and stabilizer, using, per 100 parts by weight of SEBS block copolymer, 180 parts by weight of non-olefinic thermoplastic and at least 5 parts by weight of, respectively, lubricating plasticizer and filler.

B4: TPE-S+non-olefinic thermoplastic material

Thermolast K STC 7849/43; Shore hardness A 45, density 1.06 g/cm⁴; composition made from high-molecular-weight, functionalized and non-functionalized SEBS block copolymer, lubricating plasticizer, non-olefinic thermoplastic (proportion 25% by weight), inorganic filler and stabilizer, using, per 100 parts by weight of SEBS block copolymer, 80 parts by weight of non-olefinic thermoplastic and at least 5 parts by weight of, respectively, lubricating plasticizer and filler.

B5: TPE-S+non-olefinic thermoplastic material

THERMOLAST K HTF 8075/16; Shore hardness A 48, density 1.07 g/cm³; composition made from high-molecular-weight, functionalized and non-functionalized SEBS block copolymer (100 pphr in total), lubricating plasticizer (from 5 to 200 pphr), non-olefinic thermoplastic (70 pphr), inorganic filler (from 5 to 200 pphr) and FDA- and BGVV-compliant stabilizers.

B6: TPE-S+non-olefinic thermoplastic material

THERMOLAST K HTF 7849/99; Shore hardness A 70, density 1.01 g/cm³; composition made from high-molecular-weight, functionalized and non-functionalized SEBS block copolymer (100 pphr in total), lubricating plasticizer (from 5 to 200 pphr), non-olefinic thermoplastic (180 pphr) and FDA- and BGVV-compliant stabilizers.

The Thermolast K grades (B1-B6) listed above are products marketed by Gummiwerke Kraiburg GmbH & Co. (Waldkraiburg, Germany).

Tables

Table 1 shows the results of the insert injection-molding experiments on a variety of polyacetal grades (A1-A7) with the styrene-olefin elastomer compositions (B2-B4) according to the invention, compared with a styrene-olefin elastomer (B1) modified with olefinic thermoplastic material and showing no adhesion, and also compared with a TPE-U (B0). It can be seen that modifying the polyacetal has little effect on the adhesion results. However, the homopolymer tends towards poorer bond strengths. The TPE-U had the known disadvantages in processing, in particular mold-release problems.

Table 2 shows the influence of processing parameters in another series of experiments (with in each case only 5 tensile specimens). The processing parameters had only a small influence on adhesion for the modified styrene-olefin elastomer (B4) used according to the invention. The bond strengths (and the associated elongations at break) tend toward somewhat higher values at a higher insertion temperature and a lower injection rate. The melt temperature gave an optimum at about 250° C. for the machine configuration used (residence time controlled by screw diameter). The mold temperature is ideally from about 60 to 80° C. for POM and the styrene-olefin elastomer modified with non-olefinic thermoplastic material.

Table 3 supplements Table 1 and shows the results of experiments with polyacetal grades A1 and A3 and with the FDA/BGW-compliant styrene-olefin elastomer compositions B5 and B6 according to the invention.

TABLE 1
Results with novel modified SEBS compositions compared with conventional SEBS composition and with TPE-U

| | | Component b) | | | | |
|---|---|---|---|---|---|---|
| | | | B1 | B2 | B3 | B4 |
| | | | Thermolast K | Thermolast K | Thermolast K | Thermolast K |
| | | BO | TC 6AAA | STC 7480/44 | STC 7849/42 | STC 7849/43 |
| | | Shore A 83 | Shore A 58 | Shore A 75 | Shore A 75 | Shore A 45 |
| | Tme [° C.], Tmo [° C.] | 200, 80 | 240, 60 | 240, 60 | 240, 60 | 240, 60 |
| 100% = | pa [bar]/tpa [s] | 80/30 | 50/15 | 50/15 | 50/15 | 40/15 |
| 200 mm/sec | vₗ [%] | 100 | 75 | 75 | 75 | 75 |
| Component a) | T insert [° C.] | 155 | 155 | 155 | 155 | 155 |
| A1 | Bond strength [N/mm²] ± | 2.9 ± 0.1 | no | 1.6 ± 0.3 | 1.6 ± 0.1 | 1.0 ± 0.0 |
| | std. dev. | | adhesion | | | |
| | Elong. at break [%] ± | 8.6 ± 0.5 | | 5.3 ± 1.0 | 5.7 ± 0.5 | 18.5 ± 0.7 |
| | std. dev. | | | | | |
| A2 | Bond strength [N/mm²] ± | 3.5 ± 0.2 | no | 1.1 ± 0.2 | 1.4 ± 0.1 | 1.0 ± 0.0 |
| | std. dev. | | adhesion | | | |
| | Elong. at break [%] ± | 30.7 ± 2.9 | | 6.0 ± 2.3 | 8.3 ± 2.7 | 19.2 ± 1.5 |
| | std. dev. | | | | | |
| A3 | Bond strength [N/mm²] ± | 4.2 ± 0.4 | no | 1.6 ± 0.2 | 1.6 ± 0.1 | 1.0 ± 0.0 |
| | std. dev. | | adhesion | | | |
| | Elong. at break [%] ± | 36.7 ± 9.8 | | 7.2 ± 1.3 | 5.8 ± 0.5 | 19.2 ± 1.3 |
| | std. dev. | | | | | |
| A4 | Bond strength [N/mm²] ± | 3.0 ± 0.3 | no | 1.3 ± 0.1 | 1.3 ± 0.3 | 1.0 ± 0.0 |
| | std. dev. | | adhesion | | | |
| | Elong. at break [%] ± | 16.4 ± 3.3 | | 5.1 ± 0.5 | 6.1 ± 1.6 | 19.5 ± 2.1 |
| | std. dev. | | | | | |
| A5 | Bond strength [N/mm²] ± | 3.2 ± 0.4 | no | 1.6 ± 0.2 | 1.7 ± 0.1 | 1.0 ± 0.0 |
| | std. dev. | | adhesion | | | |
| | Elong. at break [%] ± | 23.7 ± 7.6 | | 7.3 ± 1.2 | 9.2 ± 1.4 | 20.7 ± 0.9 |
| | std. dev. | | | | | |
| A6 | Bond strength [N/mm²] ± | 2.0 ± 0.1 | no | no | 0.5 ± 0.2 | 1.0 ± 0.0 |
| | std. dev. | | adhesion | adhesion | | |
| | Elong. at break [%] ± | 4.7 ± 0.4 | | | 1.6 ± 0.7 | 19.5 ± 2.1 |
| | std. dev. | | | | | |
| A7 | Bond strength [N/mm²] ± | 2.8 ± 0.2 | no | 1.6 ± 0.4 | 1.7 ± 0.1 | 1.0 ± 0.0 |
| | std. dev. | | adhesion | | | |
| | Elong. at break [%] ± | 7.9 ± 0.8 | | 5.1 ± 1.5 | 6.4 ± 0.3 | 18.9 ± 1.4 |
| | std. dev. | | | | | |

TABLE 2
Influence of processing on the adhesion of novel modified SEBS composition to POM

| | | Component b) | | | | |
|---|---|---|---|---|---|---|
| | | B4 | B4 | B4 | B4 | B4 |
| | | Thermolast | Thermolast | Thermolast | Thermolast | Thermolast |
| | | KSTC7849/43 | KSTC7849/43 | KSTC7849/43 | KSTC7849/43 | KSTC7849/43 |
| | Tme [° C.], Tmo [° C.] | 220, 60 | 240, 60 | 250, 60 | 250, 60 | 250, 60 |
| | pa [bar]/tpa [s] | 40/15 | 40/15 | 40/15 | 40/15 | 40/15 |
| Compo- | vₗ [%] | 75 | 75 | 75 | 75 | 75 |
| nent a) | T insert [° C.] | 155 | 155 | RT | 100 | 155 |
| A1 | Bond strength [N/mm²] ± std. dev. | 0.7 ± 0.0 | 0.8 0.1 | 0.6 ± 0.0 | 0.8 ± 0.0 | 0.9 ± 0.1 |
| | Elong. at break [%] ± std. dev. | 10.5 ± 0.9 | 13.7 ± 3.0 | 9.4 ± 1.1 | 15.8 ± 0.8 | 17.0 ± 0.7 |
| | | Component b) | | | | |
| | | B4 | B4 | B4 | B4 | B4 |
| | | Thermolast | Thermolast | Thermolast | Thermolast | Thermolast |
| | | KSTC7849/43 | KSTC7849/43 | KSTC7849/43 | KSTC7849/43 | KSTC7849/43 |
| | Tme [° C.], Tmo [° C.] | 250, 60 | 250, 60 | 260, 60 | 260, 60 | 260, 80 |
| | pa [bar]/tpa [s] | 40/15 | 40/15 | 40/15 | 40/15 | 40/15 |
| Compo- | vₗ [%] | 50 | 25 | 50 | 75 | 75 |
| nent a) | T insert [° C.] | 155 | 155 | 155 | 155 | 155 |
| A1 | Bond strength [N/mm²] ± std. dev. | 0.9 ± 0.0 | 0.8 ± 0.1 | 0.7 ± 0.1 | 0.7 ± 0.1 | 0.6 ± 0.2 |
| | Elong. at break [%] ± std. dev. | 17.6 ± 1.2 | 17.8 ± 3.6 | 16.8 ± 1.8 | 14.7 ± 1.9 | 12.3 ± 5.4 |

N.B. only 5 specimens of each formulation used

TABLE 3
Results with novel
FDA/BGVV-compliant modified SEBS compositions

| | | B5 | B6 |
|---|---|---|---|
| | | Thermolast K | Thermolast K |
| | | HTF8075/16 | HTF7849/99 |
| | Component b) | Shore A 48 | Shore A 70 |
| | Tme [° C.], Tmo [° C.] | 250, 60 | 250, 60 |
| 100% = | pa [bar]/tpa [s] | 40/15 | 40/15 |
| 200 mm/sec | vₗ [%] | 50 | 50 |
| Component | T insert [° C.] | 155 | 155 |
| a) | | | |
| A1 | Bond strength | 1.0 ± | 1.7 ± |
| | [N/mm²] ± std. dev. | 0.1 | 0.1 |
| | Elong. at break [%] ± | 18.3 ± | 8.9 ± |
| | std. dev. | 2.0 | 0.7 |
| A3 | Bond strength | 0.9 ± | 1.7 ± |
| | [N/mm²] ± std. dev. | 0.0 | 0.1 |
| | Elong. at break [%] ± | 16.5 = | 8.6 ± |
| | std. dev. | 1.3 | 0.9 |

1: A composite article made from polyacetal and from at least one modified styrene-olefin elastomer, formed by a polyacetal molding which has to some extent or completely been coated with the modified styrene-olefin elastomer, or to which one or more moldings made from the modified styrene-olefin elastomer have been directly molded-on, where the modified styrene-olefin elastomer is a composition which comprises from 20 to 85% by weight of functionalized and/or non-functionalized styrene-olefin block copolymer, built up from rigid end-blocks of styrene and from flexible middle blocks of olefin, and from 15 to 70% by weight of non-olefinic thermoplastic material, and also at least 5 parts by weight respectively and not more than 200 parts by weight respectively of lubricating plasticizer and/or inorganic filler per 100 parts by weight of styrene-olefin block copolymer, and wherein the modified styrene-olefin has a Shore A hardness of from 30 to 90.

2: A composite article as claimed in claim 1, wherein the polyacetal and the modified styrene-olefin elastomer have been adhesively bonded to one another.

3: A composite article as claimed in claim 1, wherein the strength of the bond between the polyacetal and the modified styrene-olefin elastomer is at least 0.5 N/mm².

4: A composite article as claimed claim 1, wherein the polyacetal used comprises a polyoxymethylene copolymer.

5: A composite article as claimed in claim 1, wherein the non-olefinic thermoplastic material has been selected from the class consisting of thermoplastic polyesterurethane elastomers, thermoplastic polyetherurethane elastomers, thermoplastic polyesters, thermoplastic polyesterester elastomers, thermoplastic polyetherester elastomers, thermoplastic polyetheramide elastomers, thermoplastic polyamides, thermoplastic polycarbonates, thermoplastic polyacrylates, acrylate rubbers and styrene-acrylonitrile-acrylate rubbers (ASA).

6: A composite article as claimed in claim 1, in the form of a molding made from polyacetal, which has been entirely or to some extent coated with the modified styrene-olefin elastomer.

7: A composite article as claimed in claim 1, in the form of a molding made from polyacetal, to which at least one other molding made from the modified styrene-olefin elastomer has been molded-on.

8: A composite article as claimed in claim 1, which has been produced by multicomponent injection molding.

9: A composite article as claimed in claim 8, wherein the molding is firstly molded from polyacetal and then a coating or a molding made from the modified styrene-olefin elastomer is injected onto the polyacetal molding.

10: A process for producing a composite article made from polyacetal and from at least one modified styrene-olefin elastomer, where the modified styrene-olefin elastomer comprises from 15 to 70% by weight of non-olefinic thermoplastic material, and where a molding is firstly molded from polyacetal, onto which is then molded a coating or at least one molding made from the modified styrene-olefin elastomer, giving an adhesive bond between the polyacetal and the modified styrene-olefin elastomer.

11: The process as claimed in claim 10, which is a multicomponent injection-molding process carried out in a mold, where the molding made from polyacetal has been preheated to a temperature in the range from 80° C. to just below its melting point prior to molding-on of the modified styrene-olefin elastomer, the melt temperature of the modified styrene-olefin elastomer is from 200 to 270° C. during molding onto the molding made from polyacetal, and the temperature control of the mold has been set to a temperature in the range from 20 to 140° C.

12: The process as claimed in claim 11, wherein the molding made from polyacetal has been preheated to a temperature in the range from 100 to 160° C., the melt temperature of the modified styrene-olefin elastomer is from 220 to 260° C., and the temperature control of the mold has been set to a temperature in the range from 30 to 80° C.

13: A composite article as claimed in claim 2, wherein the strength of the bond between the polyacetal and the modified styrene-olefin elastomer is at least 0.5 N/mm² and the modified styrene-olefin has a Shore A hardness of from 40 to 80.

14: A composite article as claimed claim 13, wherein the polyacetal used comprises a polyoxymethylene copolymer.

15: A composite article as claimed in claim 14, wherein the non-olefinic thermoplastic material has been selected from the class consisting of thermoplastic polyesterurethane elastomers, thermoplastic polyetherurethane elastomers, thermoplastic polyesters, thermoplastic polyesterester elastomers, thermoplastic polyetherester elastomers, thermoplastic polyetheramide elastomers, thermoplastic polyamides, thermoplastic polycarbonates, thermoplastic polyacrylates, acrylate rubbers and styrene-acrylonitrile-acrylate rubbers (ASA).

16. The process as claimed in claim 10, wherein the modified styrene-olefin elastomer comprises from 20 to 50% by weight of non-olefinic thermoplastic material, and 35 to 70% by weight of maleic anhydride-functionalized and/or non-functionalized tri-block compolymer which have been built up form rigid end-blocks of styrene and from flexible middle blocs of olefin.

17. The process as claimed in claim 16, which further comprises at least 5 parts by weight and not more than 200 parts by weight of a lubricating plasticizer or an inorganic filler a mixture of the lubricating plasticizer and the inorganic filler, per 100 parts by weight of styrene-olefin block copolymer.
